(19) United States
(12) Patent Application Publication
(10) Pub. No.: US 2013/0223863 A1
(43) Pub. Date: Aug. 29, 2013

(54) IMAGE FORMING APPARATUS

(71) Applicant: FUJI XEROX CO., LTD., (US)

(72) Inventors: Atsushi OGIHARA, Kanagawa (JP); Atsuyuki KITAMURA, Kanagawa (JP); Masahiro SATO, Kanagawa (JP); Tetsuji OKAMOTO, Kanagawa (JP); Koichi WATANABE, Kanagawa (JP); Wataru SUZUKI, Kanagawa (JP); Shuichi NISHIDE, Kanagawa (JP)

(73) Assignee: FUJI XEROX CO., LTD., Tokyo (JP)

(21) Appl. No.: 13/653,026

(22) Filed: Oct. 16, 2012

(30) Foreign Application Priority Data
Feb. 23, 2012 (JP) 2012-037705

(51) Int. Cl. G03G 15/16

(52) U.S. Cl. 399/66; 399/304

(57) ABSTRACT

An image forming apparatus includes an image carrier; a transfer body; a leading-end gripping member that grips a leading-end portion of the recording medium when the recording medium is transported and that releases the leading-end portion when the recording medium to which a final toner image starts being transferred is separated from the transfer body; and a controller that controls a peripheral velocity of the transfer body and a peripheral velocity of the image carrier to change a ratio between the peripheral velocity of the transfer body and the peripheral velocity of the image carrier from a first ratio for transferring a toner image that precedes the final toner image to the recording medium to a second ratio for transferring the final toner image to the recording medium by making the peripheral velocity of the transfer body higher than the peripheral velocity of the image carrier.

### CROSS-REFERENCE TO RELATED APPLICATIONS

This application is based on and claims priority under 35 USC 119 from Japanese Patent Application No. 2012-037705 filed Feb. 23, 2012.

### BACKGROUND

The present invention relates to image forming apparatuses.

### SUMMARY

According to an aspect of the invention, an image forming apparatus includes an image carrier on whose surface toner images are sequentially formed while the image carrier rotates; a transfer body around whose outer circumferential surface a recording medium is wrapped, the transfer body transporting the recording medium to a transfer position, at which the transfer body faces the image carrier, multiple times while rotating to sequentially transfer the toner images formed on the surface of the image carrier to the recording medium; a leading-end gripping member that grips a leading-end portion of the recording medium when the recording medium is transported while being wrapped around the outer circumferential surface of the transfer body and that releases the leading-end portion of the recording medium when the recording medium to which a final toner image starts being transferred is separated from the transfer body, the final toner image being one of the toner images that is lastly transferred to the recording medium; and a controller that controls a peripheral velocity of the transfer body and a peripheral velocity of the image carrier to change a ratio between the peripheral velocity of the transfer body and the peripheral velocity of the image carrier from a first ratio for transferring a toner image that precedes the final toner image to the recording medium to a second ratio for transferring the final toner image to the recording medium by making the peripheral velocity of the transfer body higher than the peripheral velocity of the image carrier.

### BRIEF DESCRIPTION OF THE DRAWINGS

Exemplary embodiments of the present invention will be described in detail based on the following figures, wherein:

FIG. 1 illustrates a state where a leading-end gripper of an image forming apparatus according to a first exemplary embodiment of the present invention passes a transfer position and releases a leading-end portion of a sheet medium P when seen from the side;

FIGS. 2A and 2B illustrate states where the leading-end gripper of the image forming apparatus according to the first exemplary embodiment is in a releasing state and in a gripping state when seen from the side;

FIG. 3A is a developed view of a transfer drum, the leading-end gripper, and a trailing-end gripper of the image forming apparatus according to the first exemplary embodiment, and FIG. 3B is a side view of the transfer drum, the leading-end gripper, and the trailing-end gripper;

FIGS. 4A and 4B schematically illustrate a configuration of the trailing-end gripper of the image forming apparatus according to the first exemplary embodiment;

FIGS. 5A and 5B schematically illustrate a configuration of the transfer drum and the trailing-end gripper of the image forming apparatus according to the first exemplary embodiment;

FIGS. 6A, 6B, 6C, and 6D illustrate a series of states in which a sheet medium P is wrapped around the transfer drum of the image forming apparatus according to the first exemplary embodiment;

FIGS. 7A, 7B, 7C, and 7D illustrate a series of states in which a sheet medium P that has been wrapped around the transfer drum of the image forming apparatus according to the first exemplary embodiment is separated from the transfer drum;

FIG. 8 schematically illustrates the surroundings of a transfer position Tr of the image forming apparatus according to the first exemplary embodiment; and

FIG. 9 schematically illustrates the image forming apparatus according to the first exemplary embodiment.

### DETAILED DESCRIPTION

### First Exemplary Embodiment

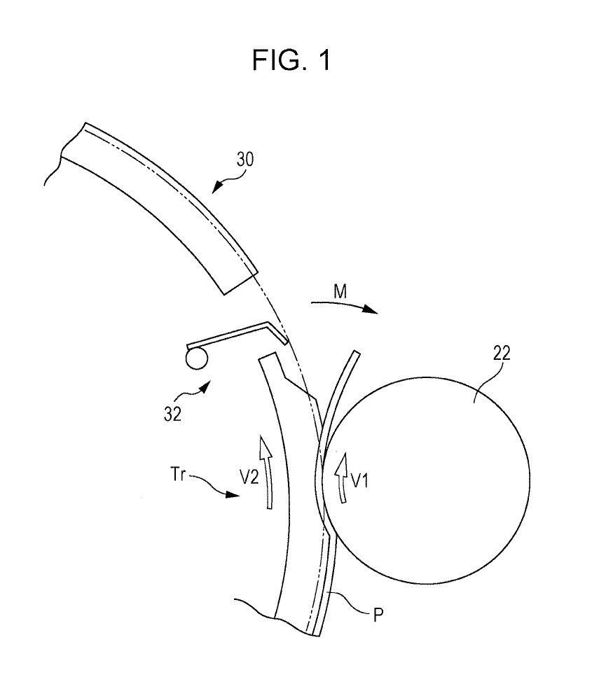

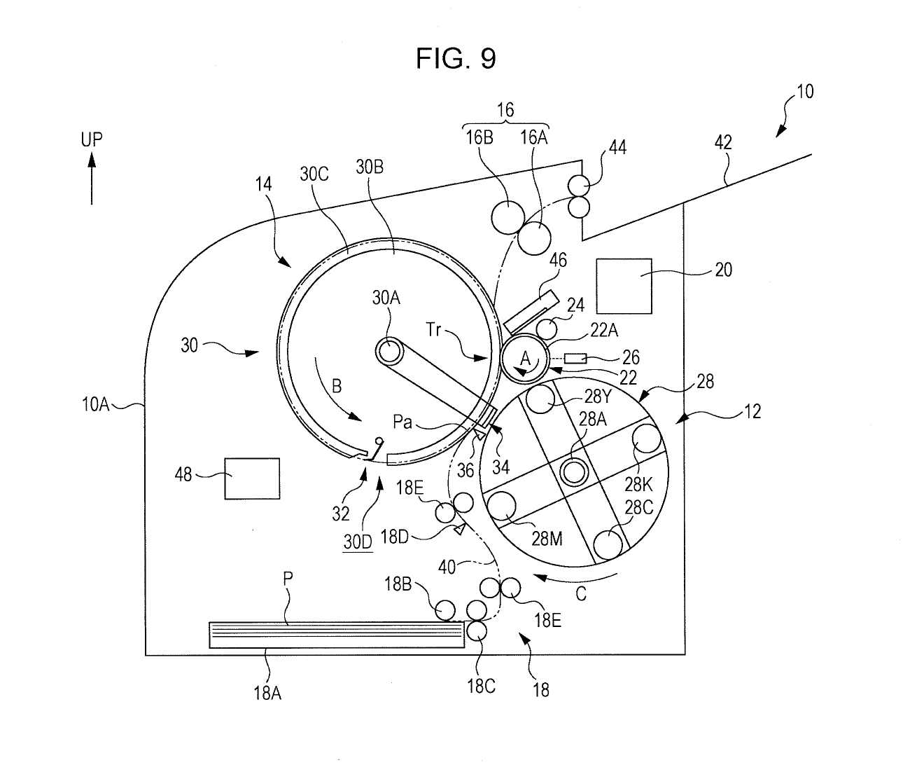

An image forming apparatus 10 according to a first exemplary embodiment of the present invention will be described referring to FIGS. 1 to 9. The arrow UP illustrated in FIG. 9 indicates a vertically upward direction.

### Entire Configuration

As illustrated in FIG. 9, the image forming apparatus 10 according to the first exemplary embodiment of the present invention includes an image forming unit 12, a transfer device 14, a fixing device 16, a sheet feeding unit 18, and a controller 20. The image forming unit 12 forms a toner image. A sheet medium P is a recording medium and is fed to the transfer device 14, and the transfer device 14 transfers the toner image, having been formed by the image forming unit 12, to the sheet medium P that is wrapped around the transfer device 14. The fixing device 16 fixes the toner image, having been formed on the sheet medium P released from the transfer device 14, on the sheet medium The sheet feeding unit 18 feeds the sheet medium P to the transfer device 14. The controller 20 controls the entirety of the image forming apparatus 10.

### Image Forming Unit

The image forming unit 12 that forms a toner image will be described first.

The image forming unit 12 includes an image carrier 22, on whose surface toner images are sequentially formed while the image carrier 22 is rotating. The image forming unit 12 also includes a charging device 24, an exposing device 26, a rotary developing device 28, and a cleaning device 46. The charging device 24 charges the surface of the image carrier 22. The exposing device 26 exposes the charged surface of the image carrier 22 to light to form an electrostatic latent image. The rotary developing device 28 develops the electrostatic latent image, having been formed on the surface of the image carrier 22, by using a developer into a toner image. The cleaning device 46 removes remnants remaining on the image carrier 22.

### Image Carrier

The image carrier 22 is disposed so as to rotate in the arrow A direction and includes a negatively charged photosensitive layer 22A on the surface. The outside diameter of the image carrier 22 is 30.0 mm, for example. The charging device 24, the exposing device 26, the rotary developing device 28, and the cleaning device 46 are arranged around the image carrier 22 in this order in the arrow A direction. The image carrier 22 also includes a driving source (not illustrated) that drives the image carrier 22 to rotate at a peripheral velocity V1.

### Charging Device

The charging device 24 is arranged so as to face the image carrier 22. The charging device 24 is a roller-type charger that charges the surface of the image carrier 22 with a charging bias supplied from a charging-bias power source (not illustrated) while the charging device 24 is driven to rotate by the rotating image carrier 22.

### Exposing Device

The exposing device 26 irradiates the surface of the image carrier 22 having been charged by the charging device 24 with light to form an electrostatic latent image. In this exemplary embodiment, the exposing device 26 includes, for example, multiple light emitting diodes (LEDs, which are not illustrated).

Rotary Developing Device

The rotary developing device 28 includes a rotation shaft 28A and developing portions 28Y, 28M, 26C, and 28K for yellow (Y), magenta (M), cyan (C), and black (K) arranged around the rotation shaft 28A. The rotary developing device 28 rotates in the arrow C direction around the rotation shaft 28A.

In the rotary developing device 28, each of the developing portions 28Y, 28M, 26C, and 28K is positioned at a position opposite the image carrier 22. The rotary developing device 28 then sequentially develops the electrostatic latent images having been formed on the image carrier 22 by the exposing device 26 into toner images of the different colors by using a development bias supplied from a development-bias power source (not illustrated).

These developing portions 28Y, 28M, 26C, and 28K contain developers of corresponding colors.

### Cleaning Device

The cleaning device 46 recovers toner remaining on the surface of the image carrier 22 without being transferred to the sheet medium P by the transfer device 14, which will be described below, or other remnants from the surface of the image carrier 22. The cleaning device 46 according to the exemplary embodiment is a blade-type cleaner.

### Transfer Device

Now, description will be given on the transfer device 14 around which a sheet medium P is wrapped and that transfers a toner image having been formed by the image forming unit 12 to the wrapped sheet medium P.

The transfer device 14 includes a transfer drum 30, a leading-end gripper 32, and a trailing-end gripper 34. The transfer drum 30 is taken as an example of a transfer body around which a sheet medium P, to which a toner image on the image carrier 22 is transferred, is wrapped. The leading-end gripper 32 is taken as an example of a leading-end gripping member that grips a leading-end portion of the sheet medium P wrapped around the transfer drum 30. The trailing-end gripper 34 is taken as an example of a trailing-end gripping member that restricts the position of a trailing-end portion of the sheet medium P.

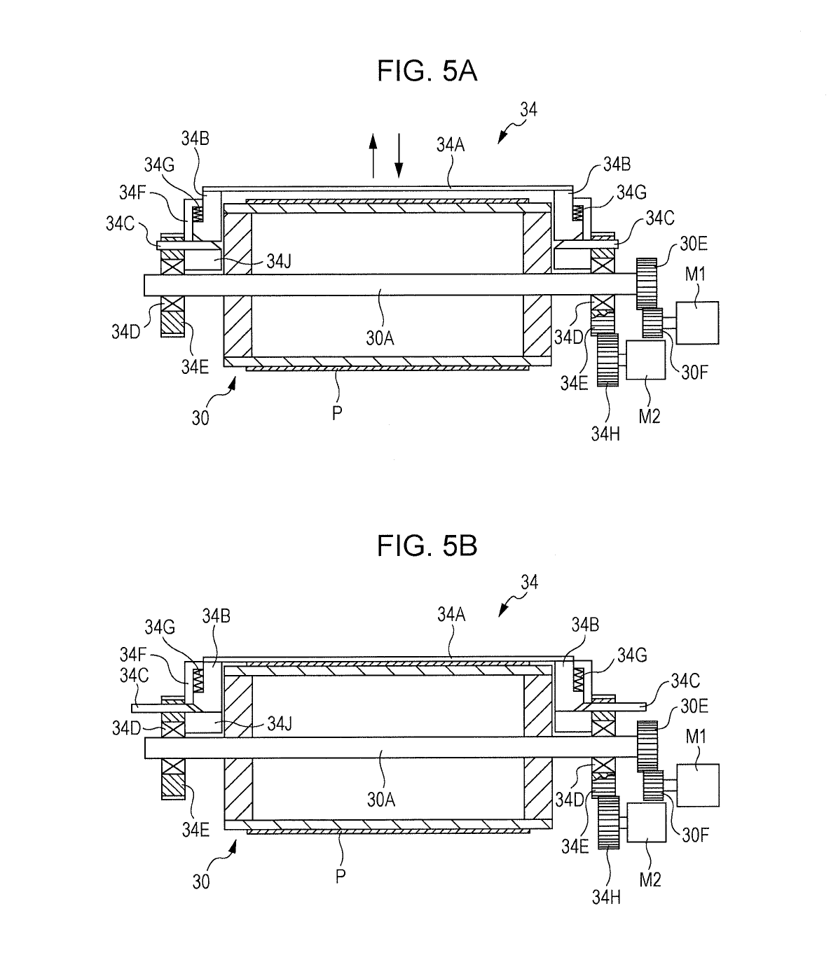

The transfer device 14 also includes a sheet sensor 36 that detects a sheet medium P passing thereby, a driving motor M1 (see FIGS. 5A and 5B) that drives the transfer drum 30 to rotate, and a power source 48 that applies a transfer bias, which is a voltage of a polarity opposite to that of the toner, to the transfer drum 30.

### Transfer Drum

The transfer drum 30 arranged so as to face the image carrier 22 includes a rotation shaft 30A, a drum-shaped base portion 30B, and an elastically deformable elastic layer 30C that is formed around the outer circumferential surface of the base portion 30B. The outside diameter of the transfer drum 30 is 119.4 mm, for example.

The elastic layer 30C, from a leading end to a trailing end of the elastic layer 30C in a direction in which the sheet medium P is transported, lies along the outer circumference of the drum-shaped base portion 30B. A portion of the transfer drum 30 around which even a maximum-size sheet medium P is not wrapped is a cutout region 30D, in which the elastic layer 30C is absent such that a part of the elastic layer 30C in the circumferential direction of the transfer drum 30 is cut out.

The dimensions of the transfer drum 30 and the image carrier 22 and the positional relationship between the transfer drum 30 and the image carrier 22 are determined such that the transfer drum 30 and the image carrier 22 do not contact each other when the cutout region 30D of the transfer drum 30 faces the image carrier 22. A dielectric substance, such as a dielectric sheet, is not attached to the outer circumferential surface of the elastic layer 30C, and thus wrapping of a sheet medium P around the transfer drum 30 does not involve the use of electrostatic attraction.

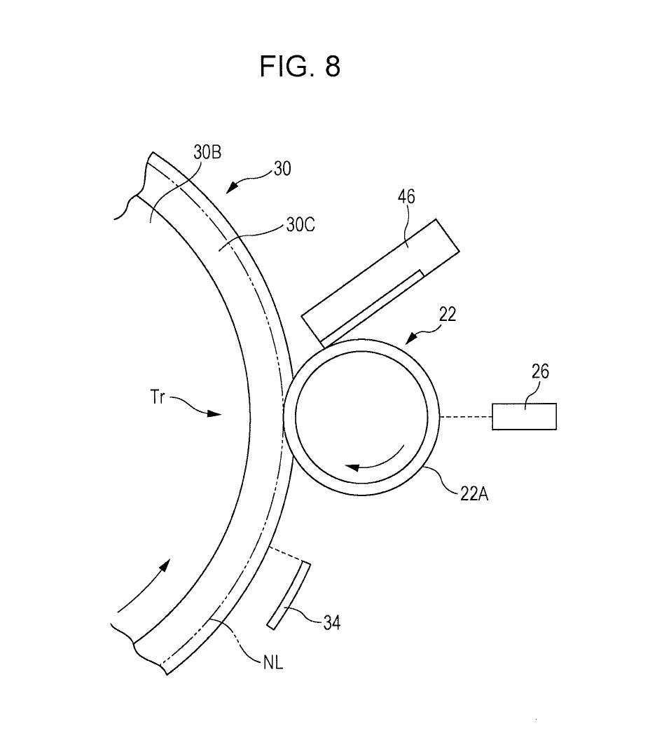

As illustrated in FIG. 8, at a transfer position Tr at which the transfer drum 30 and the image carrier 22 face each other to transfer a toner image to the sheet medium P, the elastic layer 30C of the transfer drum 30 is pressed by the image carrier 22. Here, the elastic layer 30C is pressed by the image carrier 22 down to a compressed circumference NL illustrated in FIG. 8 with the two-dot chain line.

At the transfer position Tr, transportation of the sheet medium P that is nipped by the transfer drum 30 and the image carrier 22 is performed dominantly by using electrostatic attraction of the image carrier 22.

As illustrated in FIGS. 5A and 5B, a gear 30E is mounted on an end portion of the rotation shaft 30A of the transfer drum 30 and meshes with a gear 30F mounted on an output shaft of the driving motor M1, which drives the transfer drum 30 to rotate.

### Sheet Sensor

As illustrated in FIG. 9, the sheet sensor 36 is disposed so as to face the outer circumferential surface of the transfer drum 30. The sheet sensor 36 irradiates the sheet medium P, which is transported while being wrapped around the transfer drum 30, with infrared light, and detects the sheet medium P passing thereby using the reflected light.

The sheet sensor 36 is disposed upstream from a stand-by position of the trailing-end gripper 34 (the position of the trailing-end gripper 34 illustrated in FIG. 9), which will be described in detail below, and downstream from a feeding-sheet position Pa at which a sheet medium P is fed to the transfer drum 30, in the direction in which the sheet medium P is transported.

### Leading-End Gripper

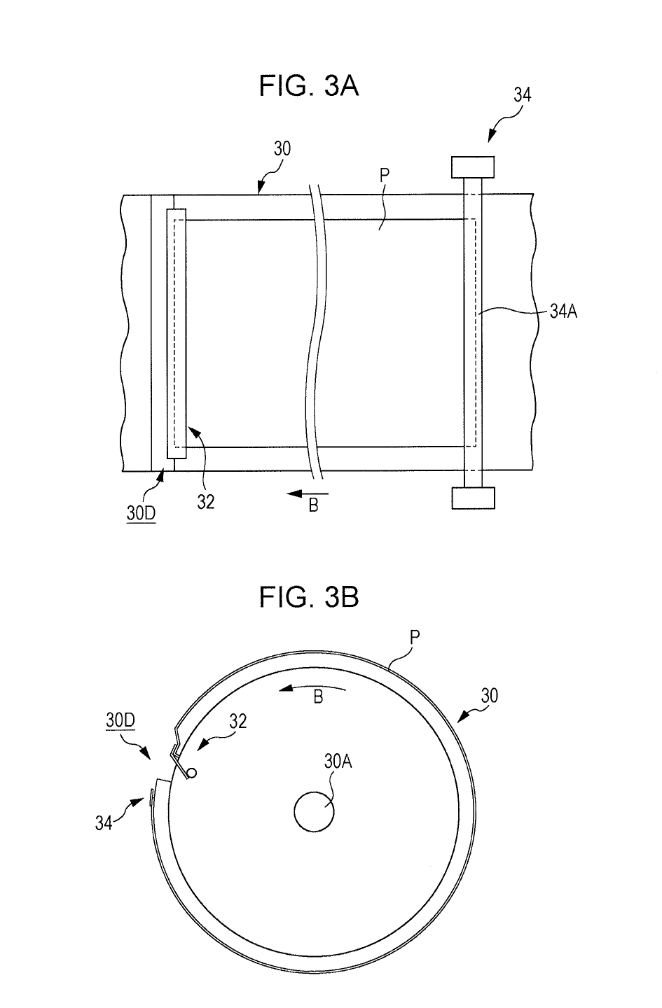

As illustrated in FIGS. 3A and 3B, the leading-end gripper 32 that grips the leading-end portion of the sheet medium P wrapped around the transfer drum 30 is attached to the transfer drum 30, and is disposed in the cutout region 30D. FIG. 3A is a developed view in which the outer circumferential surface of the transfer drum 30 is developed.

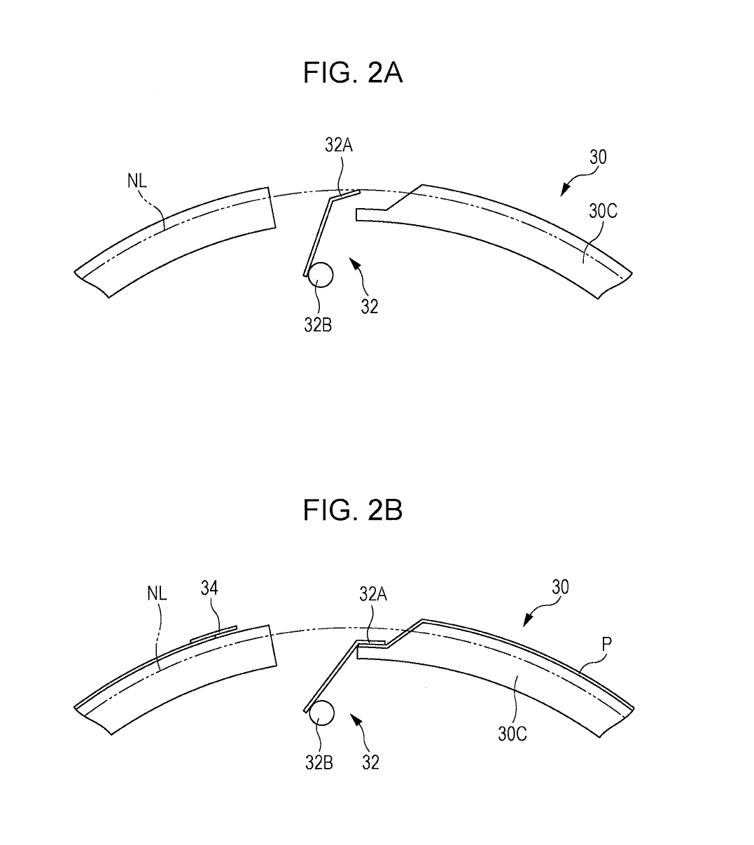

As illustrated in FIGS. 2A and 2B, the leading-end gripper 32 includes a pressing plate 32A and a shaft member 32B. The pressing plate 32A presses the leading-end portion of the sheet medium P against the elastic layer 30C. The shaft member 32B rotates the pressing plate 32A such that the pressing plate 32A grips or releases the leading-end portion of the sheet medium P.

The pressing plate 32A extends in a direction of a rotation axis of the transfer drum 30 (hereinafter also referred to as a “drum axis direction”, simply). For example, the pressing plate 32A is formed by bending a stainless steel plate, and has a single bent portion when viewed in the drum axis direction.

An axis direction of the shaft member 32B is parallel to the drum axis direction. The shaft member 32B, which is cylindrical, is secured to a first end portion of the pressing plate 32A. Accordingly, when the shaft member 32B is rotated, the leading-end gripper 32 moves so as to switch between a gripping state (see FIG. 2B), in which a second end portion of the pressing plate 32A grips the leading-end portion of the sheet medium P, and a releasing state (see FIG. 2A), in which the second end portion releases the leading-end portion of the sheet medium P.

As illustrated in FIGS. 2A and 2B, a locus of the leading-end gripper 32 that moves so as to switch between the gripping state and the releasing state is formed on the inner side of the compressed circumference NL, and thus the leading-end gripper 32 does not contact the image carrier 22. In other words, the leading-end gripper 32 is located outside a region of the elastic layer 30C that is compressed by the image carrier 22, and thus when the leading-end gripper 32 has been moved to the transfer position Tr, the leading-end gripper 32 is separated from the image carrier 22.

### Trailing-End Gripper

As illustrated in FIGS. 3A and 3B, the trailing-end gripper 34 is stretched across the transfer drum 30 in the drum axis direction, and rotates around the rotation shaft 30A independently of the transfer drum 30.

As illustrated in FIGS. 5A and 5B, the trailing-end gripper 34 includes a sheet restricting portion 34A extending in the drum axis direction, and holding portions 34B that hold both end portions of the sheet restricting portion 34A. The sheet restricting portion 34A stops the trailing-end portion of the sheet medium P from moving.

The sheet restricting portion 34A is made of a film-formed resin material and is elastically deformable. Examples of the resin material include polyethylene terephthalate (PET), polyimide, and fluorocarbon resins.

The holding portions 34B extend in the radial direction of the transfer drum 30 (also simply referred to as a “drum radius direction”, below). The trailing-end gripper 34 also includes wedge-shaped shifting members 34C, whose movement in the drum axis direction causes the sheet restricting portion 34A to move in the drum radius direction via the holding portions 34B.

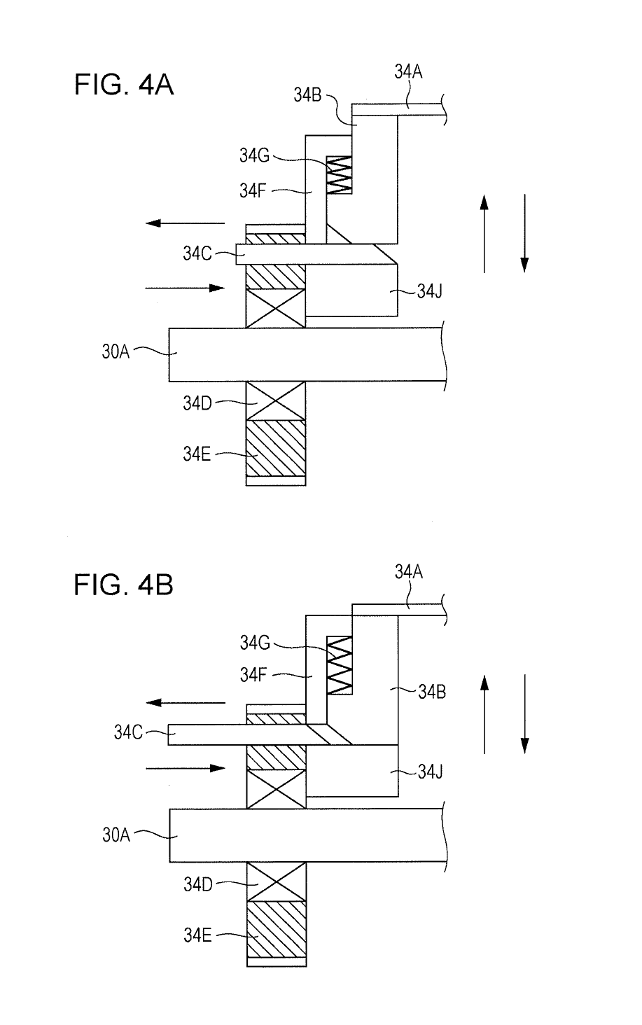

As illustrated in FIGS. 4A and 4B, gears 34E are mounted on the rotation shaft 30A via bearings 34D, and supporting portions 34F extending in the drum radius direction are disposed at the gears 34E. Each holding portion 34B is disposed so as to be movable relative to a corresponding one of the supporting portions 34F in the drum radius direction. A spring member 34G is interposed between each holding portion 34B and a corresponding supporting portion 34F, and the spring member 34G urges the holding portion 34B in a radially inward direction. The trailing-end gripper 34 also includes stopper portions 34J that restrict the positions of the holding portions 34B when the holding portions 34B having been urged by the spring members 34G in the radially inward direction abut against the stopper portions 34J.

In this configuration, when the controller 20 controls a solenoid, which is not illustrated, to move the wedge-shaped shifting members 34C in the drum axis direction into spaces between the holding portions 34B and the stopper portions 34J, the holding portions 34B are moved in a radially outward direction. With this operation, the sheet restricting portion 34A switches to the releasing state, in which the sheet restricting portion 34A becomes separated from the elastic layer 30C to release the trailing-end portion of the sheet medium P (see FIGS. 4A and 5A).

On the other hand, when the controller 20 controls a solenoid, which is not illustrated, to move the wedge-shaped shifting members 34C in the drum axis direction and pull out the wedge-shaped shifting members 34C from the spaces between the holding portions 34B and the stopper portions 34J, the holding portions 34B are moved in a radially inward direction. With this operation, the sheet restricting portion 34A switches to the restricting state in which the sheet restricting portion 34A brings the sheet medium P into contact with the elastic layer 30C such that the sheet medium P becomes flush with the elastic layer 30C (see FIGS. 4B and 5B).

As illustrated in FIGS. 5A and 5B, a driving motor M2 that drives the trailing-end gripper 34 to rotate around the rotation shaft 30A is provided, and a gear 34H that is mounted on an output shaft of the driving motor M2 meshes with one of the gears 34E.

As described above, since the trailing-end gripper 34 is disposed as a body that is separate from the transfer drum 30, the position of the trailing-end gripper 34 relative to the transfer drum 30 is changeable.

When the leading-end gripper 32 grips the leading-end portion of the sheet medium P, the leading-end gripper 32 does not allow the sheet medium P to move in the transporting direction and stops the sheet medium P from moving away from the transfer drum 30. On the other hand, when the trailing-end gripper 34 restricts the trailing-end portion of the sheet medium P, the trailing-end gripper 34 allows the sheet medium P to move in the transporting direction but stops the sheet medium P from moving away from the transfer drum 30.

### Fixing Device

The fixing device 16 that fixes a toner image formed on a sheet medium P to the sheet medium P will be described now.

As illustrated in FIG. 9, the fixing device 16 includes a heating roller 16A and a pressurizing roller 16B. The heating roller 16A includes a heating source (not illustrated) and a rotating force is transmitted to the heating roller 16A. The pressurizing roller 16B is brought into contact with the heating roller 16A with pressure.

When a sheet medium P holding a toner image is nipped between and transported by the heating roller 16A and the pressurizing roller 16B, the toner image is melted and pressurized and is thus fixed to the sheet medium P.

Discharging rollers 44 are disposed downstream from the fixing device 16 in the direction in which the sheet medium P is transported. The discharging rollers 44 discharge the sheet medium P, having a toner image fixed thereon, to a discharge portion 42 formed on an upper surface of an apparatus body 10A.

### Sheet Feeding Unit

Now, the sheet feeding unit 18 that feeds a sheet medium P to the transfer device 14 will be described.

The sheet feeding unit 18 is disposed at a lower portion in the apparatus body 10A of the image forming apparatus 10 and includes a sheet containing member 18A, a pick-up roller 18B, separation rollers 18C, and a leading-end sensor 18D. The sheet containing member 18A contains sheet media P. The pick-up roller 18B picks up the sheet media P from the sheet containing member 18A. The separation rollers 18C separate closely-attached sheet media P from each other. The leading-end sensor 18D detects the leading-end portion of a sheet medium P passing thereby.

The sheet feeding unit 18 also includes multiple transporting rollers 18E. Each sheet medium P is transported by the transporting rollers 18E along a transport path 40.

In this manner, each sheet medium P is transported along the transport path 40 from the sheet containing member 18A to the feeding-sheet position Pa, which is positioned upstream from the transfer position Tr in the direction of rotation of the transfer drum 30.

### Operations of Entire Configuration

Now, operations of the entire configuration will be described.

Firstly, color image data that has been formed by a personal computer or the like, which is not illustrated, is input to an image signal processor (not illustrated) as red (R), green (G), and blue (B) data, for example, and is then subjected to image processing. The image data that has been subjected to image processing is converted into four-color gradation data for yellow (Y), magenta (M), cyan (C), and black (K), which is output to the exposing device 26, so that an image forming operation is started.

When the image forming operation is started, the image carrier 22 and the transfer drum 30 start rotating together at the peripheral velocity V1 and the peripheral velocity V2, respectively. At this timing, the leading-end gripper 32 and the trailing-end gripper 34 are in the releasing state.

While the leading-end gripper 32 rotates together with the transfer drum 30, the trailing-end gripper 34 remains stationary at the stand-by position without rotating together with the transfer drum 30.

The photosensitive layer 22A of the rotating image carrier 22 is charged by the charging device 24. The exposing device 26 then irradiates the image carrier 22 with light so that an electrostatic latent image for a first color (yellow, for example) based on the image information is formed on the image carrier 22.

Meanwhile, the rotary developing device 28 rotates so that a developing portion containing a toner of the color corresponding to the electrostatic latent image to be formed on the image carrier 22 (the yellow developing portion 28Y, if the corresponding color is yellow) is positioned at a position opposite the image carrier 22.

Thereafter, the developing portion 28Y develops the electrostatic latent image on the image carrier 22 to form a toner image on the image carrier 22. This toner image is transported toward the transfer position Tr, at which the toner image faces the transfer drum 30, with the rotation of the image carrier 22.

With the start of the image forming operation, feeding of a sheet medium P is also started. Specifically, sheet media P that are picked up from the sheet containing member 18A by the pick-up roller 18B are separated by the separation rollers 18C. The separated sheet media P are forwarded to the transport path 40 by the transporting rollers 18E. The leading-end sensor 18D then detects the leading-end portion of each sheet medium P passing thereby and transmits a detection signal to the controller 20.

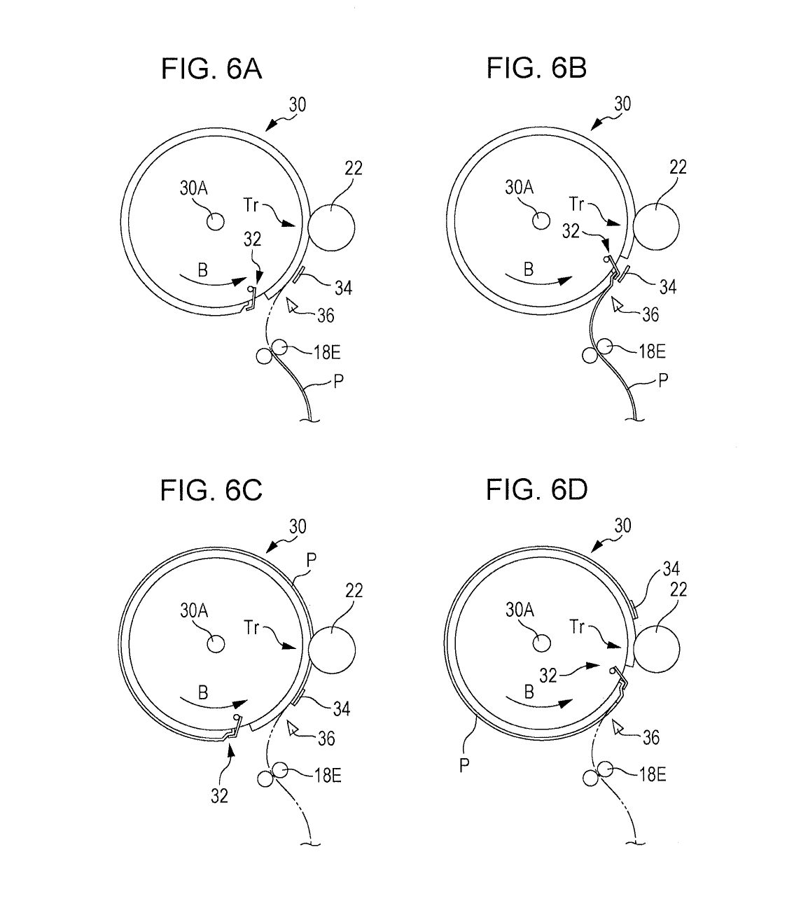

The controller 20 that has received the detection signal controls transportation of the sheet medium P on the basis of the detection signal such that the sheet medium P arrives at the feeding-sheet position Pa at the same time as when the leading-end gripper 32 arrives at the feeding-sheet position Pa (see FIG. 6A).

Here, at the time of feeding the sheet medium P, information on the size of the sheet medium P that has been detected by a sheet-size sensor (not illustrated) is transmitted to the controller 20.

As illustrated in FIG. 6B, the leading-end gripper 32 that has been in the releasing state switches to the gripping state upon arrival of the leading-end portion of the sheet medium P at the feeding-sheet position Pa. The leading-end portion of the sheet medium P is thus gripped by the leading-end gripper 32.

The leading-end gripper 32 gripping the sheet medium P then passes a position opposite the stationary trailing-end gripper 34. The leading-end gripper 32 having passed the trailing-end gripper 34 then moves toward the transfer position Tr while gripping the sheet medium P.

The sheet medium P that has passed the transfer position Tr while being gripped by the leading-end gripper 32 is consequently wrapped around the transfer drum 30 while being gripped by the leading-end gripper 32, as illustrated in FIG. 6C.

The toner image of the first color (yellow, for example) formed on the image carrier 22 is transferred to the sheet medium P on the transfer drum 30 at the transfer position Tr at which the image carrier 22 and the transfer drum 30 face each other. Part of toner remaining on the image carrier 22 after the transfer is recovered from the image carrier 22 by the cleaning device 46 (see FIG. 8).

Thereafter, the sheet sensor 36 detects the trailing-end portion of the sheet medium P passing thereby. Upon receipt of a signal from the sheet sensor 36, the controller 20 sends an instruction to the trailing-end gripper 34.

Upon receipt of the instruction, the trailing-end gripper 34 switches from the releasing state to the restricting state to restrict the trailing-end portion of the sheet medium P. The trailing-end gripper 34 that has switched to the restricting state starts rotating together with the transfer drum 30. In other words, the sheet restricting portion 34A of the trailing-end gripper 34 moves at the same velocity as the peripheral velocity V2 of the transfer drum 30.

As illustrated in FIG. 6D, the trailing-end gripper 34 rotating together with the transfer drum 30 passes the transfer position Tr while restricting the trailing-end portion of the sheet medium P.

Likewise, forming and developing of latent images for second and subsequent colors (magenta and cyan, for example), which precede a final color (black, for example), and transferring of toner images corresponding to the latent images is repeated in accordance with the above-described procedure.

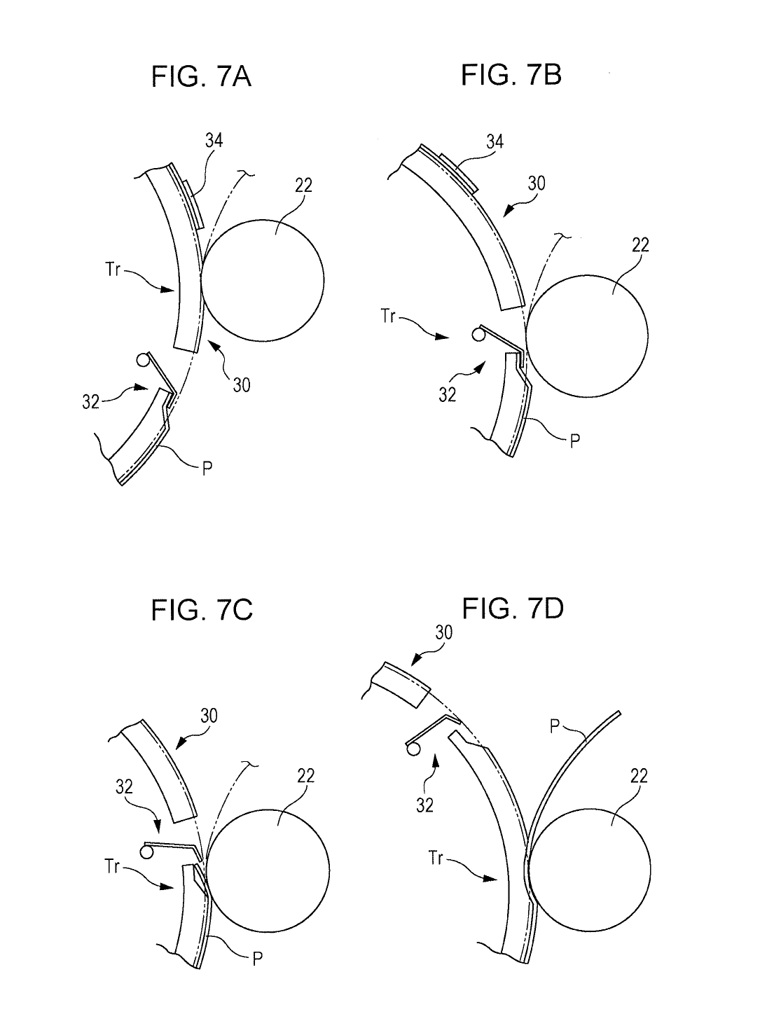

As illustrated in FIGS. 7A, 7B, and 7C, in the case of transferring a toner image of a final color (black, for example), the leading-end gripper 32 switches from the gripping state to the releasing state at the transfer position Tr, unlike in the case of transferring a toner image of a color that precedes the final color.

As illustrated in FIG. 7D, when the leading-end gripper 32 releases the leading-end portion of the sheet medium P on which multiple toner images are formed, a leading-end side of the sheet medium P becomes separated from the transfer drum 30 by being nipped by the elastic layer 30C and the image carrier 22.

The sheet medium P whose leading-end side is separated from the transfer drum 30 is transported toward the fixing device 16 illustrated in FIG. 9.

As the sheet medium P is transported further, the trailing-end gripper 34 that restricts the trailing-end portion of the sheet medium P arrives at the stand-by position. At the stand-by position, the trailing-end gripper 34 switches from the restricting state to the releasing state to release the trailing-end portion of the sheet medium P. The trailing-end gripper 34 that has switched to the releasing state stops at the stand-by position.

The toner images on the sheet medium P having been transported to the fixing device 16 are fixed to the sheet medium P by the fixing device 16. As the sheet medium P is transported further, the sheet medium P becomes separated from the transfer drum 30. The sheet medium P is finally discharged to the discharge portion 42 by the discharging rollers 44.

### Configuration of Related Portions

Now the control made by the controller 20 on the peripheral velocity V1 of the image carrier 22 and the peripheral velocity V2 of the transfer drum 30 will be described.

The controller 20 controls the peripheral velocity V1 and the peripheral velocity V2 by controlling a driving source that rotates the image carrier 22 and the driving motor M1 (see FIG. 5) that rotates the transfer drum 30.

In this configuration, the controller 20 changes the ratio of the peripheral velocity V2 to the peripheral velocity V1 from a first ratio for transferring toner images that precede a final toner image to a sheet medium P to a second ratio for transferring the final toner image to the sheet medium P by making the peripheral velocity V2 higher than the peripheral velocity V1.

Specifically, when toner images that precede the final toner image are transferred to the sheet medium P, the controller 20 makes the peripheral velocity V1, for example, approximately 0.5% to 1% higher than the peripheral velocity V2. On the other hand, when the final toner image is transferred to the sheet medium P, the controller 20 makes the peripheral velocity V2, for example, approximately 0.5% to 1% higher than the peripheral velocity V1.

The timing when the controller 20 changes the ratio between the peripheral velocities V1 and V2 is after the sheet medium P to which a toner image that immediately precedes the final toner image has been transferred passes the transfer position Tr.

### Operations of Related Portions

Operations of the related portions will be described now.

When toner images (yellow, magenta, and cyan toner images) that precede the final toner image are transferred to the sheet medium P, the controller 20 makes the peripheral velocity V1, for example, approximately 0.5% to 1% higher than the peripheral velocity V2.

In other words, while the image carrier 22 rotates at a higher peripheral velocity than the transfer drum 30, the yellow, magenta, and cyan toner images are sequentially transferred from the image carrier 22 to the sheet medium P.

On the other hand, as illustrated in FIG. 1, when the sheet medium P to which the toner image (cyan toner image) that immediately precedes the final toner image (black toner image) has been transferred passes the transfer position Tr and the final toner image is to be transferred to the sheet medium P, the controller 20 makes the peripheral velocity V2, for example, approximately 0.5% to 1% higher than the peripheral velocity V1.

In other words, while the transfer drum 30 rotates at a higher peripheral velocity than the image carrier 22, the final toner image is transferred from the image carrier 22 to the sheet medium P. The leading-end portion of the sheet medium P to which the final toner image has been transferred is released from the leading-end gripper 32, separated from the transfer drum 30, and transported to the fixing device 16 (see FIG. 9).

As described above, the transfer drum 30 rotates at a higher peripheral velocity than the image carrier 22 when the final toner image is transferred to the sheet medium P. Thus, the peripheral velocity of the leading-end gripper 32 is higher than the peripheral velocity of the image carrier 22. Transportation of the sheet medium P that is nipped between the transfer drum 30 and the image carrier 22 has been dominantly performed by using electrostatic attraction of the image carrier 22. Thus, the leading-end gripper 32 becomes separated (escapes) from the leading-end portion of the sheet medium P that moves at the same peripheral velocity as the peripheral velocity V1 of the image carrier 22. Consequently, failure to separate the sheet medium P from the transfer drum 30 caused by the leading-end gripper 32 is suppressed.

As illustrated in FIG. 1, a force (a moment of rotation) M that tries to separate the leading-end portion of the sheet medium P from the transfer drum 30 acts on the sheet medium P since the transfer drum 30 rotates at a higher peripheral velocity than the image carrier 22. Thus, failure to separate the sheet medium P from the transfer drum 30 is suppressed.

The only requirement for the controller 20 to change the ratio between the peripheral velocities V1 and V2 is that the change should be made after the sheet medium P to which the toner image that immediately precedes the final toner image has been transferred passes the transfer position Tr. Thus, changing of the ratio between the peripheral velocities V1 and V2 is allowed to be performed at any time within a longer period.

### Second Exemplary Embodiment

An image forming apparatus 10 according to a second exemplary embodiment of the present invention will be described now. Components that are the same as those in the first exemplary embodiment will be denoted by the same reference symbols and description thereof is not provided.

In the second exemplary embodiment, the controller 20 changes the ratio between the peripheral velocities V1 and V2 after a hypothetical trailing end, which is positioned so as to correspond to the position of a trailing end of a sheet medium P having a maximum allowable size, passes the transfer position Tr and the toner image that immediately precedes the final toner image is transferred to the sheet medium P.

The controller 20 changes the ratio between the peripheral velocities V1 and V2 after the hypothetical trailing end positioned so as to correspond to the trailing end of the maximum-size (legal-size) sheet medium P passes the transfer position Tr even in the case where a sheet medium P carrying toner images has a smaller size (postcard size, for example).

In the above control, the only thing that has to be considered for changing the ratio is the hypothetical trailing end positioned so as to correspond to the trailing end of the maximum-size (legal-size) sheet medium P. Thus, the time at which the ratio between the peripheral velocities V1 and V2 is changed is selected more easily.

Other operations are the same as those in the first exemplary embodiment.

### Third Exemplary Embodiment

An image forming apparatus 10 according to a third exemplary embodiment of the present invention will be described now. Components that are the same as those in the first exemplary embodiment will be denoted by the same reference symbols and description thereof is not provided.

In the third exemplary embodiment, the controller 20 changes the ratio between the peripheral velocities V1 and V2 after the sheet medium P to which the toner image that immediately precedes the final toner image has been transferred passes the transfer position Tr and when the cutout region 30D faces the image carrier 22.

In other words, the controller 20 changes the ratio between the peripheral velocities V1 and V2 while the image carrier 22 and the transfer drum 30 are separated from each other. Thus, the ratio between the peripheral velocities Vi and V2 is changed in a shorter time period than in the case where the ratio between the peripheral velocities Vi and V2 is changed while the image carrier 22 and the transfer drum 30 are in contact with each other.

Other operations are the same as those in the first exemplary embodiment.

### Fourth Exemplary Embodiment

An image forming apparatus 10 according to a fourth exemplary embodiment of the present invention will be described now. Components that are the same as those in the first exemplary embodiment will be denoted by the same reference symbols and description thereof is not provided.

In the fourth exemplary embodiment, the controller 20 changes the ratio between the peripheral velocities V1 and V2 after the leading-end portion of the sheet medium P to which a final toner image is to be transferred passes the transfer position Tr.

In other words, the controller 20 changes the ratio between the peripheral velocities V1 and V2 after the leading-end portion of the sheet medium P to which the final toner image is to be transferred is nipped between the image carrier 22 and the transfer drum 30. Thus, misregistration of the position at which the final toner image starts to be transferred to the sheet medium P is suppressed. Other operations are the same as those in first exemplary embodiment.

### Fifth Exemplary Embodiment

An image forming apparatus 10 according to a fifth exemplary embodiment of the present invention will be described now. Components that are the same as those in the first exemplary embodiment will be denoted by the same reference symbols and description thereof is not provided.

In the fifth exemplary embodiment, the controller 20 changes the ratio between the peripheral velocities V1 and V2 after the leading-end gripper 32 releases the leading-end portion of the sheet medium P.

In other words, the ratio between the peripheral velocities V1 and V2 is changed after the velocity at which the sheet medium P is transported is no longer affected by the leading-end gripper 32 gripping the leading-end portion. Thus, misregistration of the position at which the final toner image starts to be transferred to the sheet medium P is suppressed.

Other operations are the same as those in the first exemplary embodiment.

Although the present invention has been described in detail on the basis of specific exemplary embodiments, it is obvious to those skilled in the art that the present invention is not limited to the exemplary embodiments and that various other exemplary embodiments may be made within the scope of the invention. For example, in the first exemplary embodiment, the ratio between the peripheral velocities V1 and V2 is changed by inversing the relationship between the peripheral velocity V1 of the image carrier 22 and the peripheral velocity V2 of the transfer drum 30. However, the present invention is not particularly limited to this. The ratio between the peripheral velocities V1 and V2 may be changed by making the peripheral velocity V2 of the transfer drum 30 higher than the peripheral velocity V1 of the image carrier 22.

Although not particularly described in the exemplary embodiments, when the ratio between the peripheral velocities V1 and V2 is changed, only the peripheral velocity V1 of the image carrier 22 may be changed, only the peripheral velocity V2 of the transfer drum 30 may be changed, or both the peripheral velocities V1 and V2 may be changed.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An image forming apparatus comprising:
an image carrier on whose surface toner images are sequentially formed while the image carrier rotates;
a transfer body around whose outer circumferential surface a recording medium is wrapped, the transfer body transporting the recording medium to a transfer position, at which the transfer body faces the image carrier, a plurality of times while rotating to sequentially transfer the toner images formed on the surface of the image carrier to the recording medium;
a leading-end gripping member that grips a leading-end portion of the recording medium when the recording medium is transported while being wrapped around the outer circumferential surface of the transfer body and that releases the leading-end portion of the recording medium when the recording medium to which a final toner image starts being transferred is separated from the transfer body, the final toner image being one of the toner images that is lastly transferred to the recording medium; and
a controller that controls a peripheral velocity of the transfer body and a peripheral velocity of the image carrier to change a ratio between the peripheral velocity of the transfer body and the peripheral velocity of the image carrier from a first ratio for transferring a toner image that precedes the final toner image to the recording medium to a second ratio for transferring the final toner image to the recording medium by making the peripheral velocity of the transfer body higher than the peripheral velocity of the image carrier.

2. The image forming apparatus according to claim 1, wherein the controller makes the peripheral velocity of the transfer body lower than the peripheral velocity of the image carrier when a toner image that precedes the final toner image is transferred to the recording medium and the controller makes the peripheral velocity of the transfer body higher than the peripheral velocity of the image carrier when the final toner image is transferred to the recording medium.

3. The image forming apparatus according to claim 1, wherein the controller changes the ratio between the peripheral velocity of the transfer body and the peripheral velocity of the image carrier after the recording medium to which a toner image that immediately precedes the final toner image has been transferred passes the transfer position.

4. The image forming apparatus according to claim 2, wherein the controller changes the ratio between the peripheral velocity of the transfer body and the peripheral velocity of the image carrier after the recording medium to which a toner image that immediately precedes the final toner image has been transferred passes the transfer position.

5. The image forming apparatus according to claim 1, wherein the controller changes the ratio between the peripheral velocity of the transfer body and the peripheral velocity of the image carrier after a toner image that immediately precedes the final toner image is transferred to the sheet medium and a hypothetical trailing end passes the transfer position, the hypothetical trailing end being positioned so as to correspond to the position of a trailing end of a sheet medium having a maximum allowable size.

6. The image forming apparatus according to claim 2, wherein the controller changes the ratio between the peripheral velocity of the transfer body and the peripheral velocity of the image carrier after a toner image that immediately precedes the final toner image is transferred to the sheet medium and a hypothetical trailing end passes the transfer position, the hypothetical trailing end being positioned so as to correspond to the position of a trailing end of a sheet medium having a maximum allowable size.

7. The image forming apparatus according to claim 1,
wherein an outer circumference of the transfer body is defined by an elastic layer, a portion of the elastic layer in the circumferential direction of the transfer body being cut out, the elastic layer supporting the recording medium that is wrapped around the transfer body, and the elastic layer being elastically deformed by being pressed by the image carrier at the transfer position at which the elastic layer faces the image carrier,
wherein the leading-end gripping member is disposed in a cutout region, which is the portion of the elastic layer that is cut out, and
wherein the controller changes the ratio between the peripheral velocity of the transfer body and the peripheral velocity of the image carrier after the recording medium to which a toner image that immediately precedes the final toner image has been transferred passes the transfer position and when the cutout region faces the image carrier.

8. The image forming apparatus according to claim 2,
wherein an outer circumference of the transfer body is defined by an elastic layer, a portion of the elastic layer in the circumferential direction of the transfer body being cut out, the elastic layer supporting the recording medium that is wrapped around the transfer body, and the elastic layer being elastically deformed by being pressed by the image carrier at the transfer position at which the elastic layer faces the image carrier,
wherein the leading-end gripping member is disposed in a cutout region, which is the portion of the elastic layer that is cut out, and
wherein the controller changes the ratio between the peripheral velocity of the transfer body and the peripheral velocity of the image carrier after the recording medium to which a toner image that immediately precedes the final toner image has been transferred passes the transfer position and when the cutout region faces the image carrier.

9. The image forming apparatus according to claim 1, wherein the controller changes the ratio between the peripheral velocity of the transfer body and the peripheral velocity of the image carrier after the leading-end portion of the recording medium to which the final toner image is to be transferred arrives at the transfer position.

10. The image forming apparatus according to claim 2, wherein the controller changes the ratio between the peripheral velocity of the transfer body and the peripheral velocity of the image carrier after the leading-end portion of the recording medium to which the final toner image is to be transferred arrives at the transfer position.

11. The image forming apparatus according to claim 1, wherein the controller changes the ratio between the peripheral velocity of the transfer body and the peripheral velocity of the image carrier after the leading-end gripping member releases the leading-end portion of the recording medium.

12. The image forming apparatus according to claim 2, wherein the controller changes the ratio between the peripheral velocity of the transfer body and the peripheral velocity of the image carrier after the leading-end gripping member releases the leading-end portion of the recording medium.
